(19) United States
(12) Patent Application Publication
(10) Pub. No.: US 2010/0262957 A1
(43) Pub. Date: Oct. 14, 2010

(54) Network Device and System Thereof

(75) Inventor: Prashanth Uppunda, Bangalore (IN)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/757,332

(22) Filed: Apr. 9, 2010

(30) Foreign Application Priority Data
Apr. 9, 2009 (IN) 609/KOL/2009

(51) Int. Cl. G06F 9/445; G06F 9/44

(52) U.S. Cl. 717/170; 717/176

(57) ABSTRACT

A system for installation of firmware and/or configuration files, wherein the system includes a network device having a second module for enabling the installation of the firmware and/or configuration files in a plurality of network devices based on information received on the plurality of network devices in the network by a first module of the network device. The system is also used for such an installation, wherein the system permits a facility to discover network devices and to update configuration/firmware for multiple devices together from a web application running within the network device.

### BACKGROUND OF THE INVENTION

1. Field of the Invention

The present invention relates to networking systems for communication in industry and, more particularly, to a network device and system for installation of firmware and/or configuration files in a network.

2. Description of the Related Art

An industrial networking environment includes several network devices, such as wireless access points, switches, routers or gateways. These devices need to be frequently updated with latest firmware and/or configuration file to keep the network functioning properly with the latest features available for the devices in the network.

It is quite normal that, multiple devices of similar types need to be updated with the same firmware and/or the same configuration file. One option is to update the firmware/configuration by manually accessing the web page of each device and performing the necessary updates. However, updating in this manner is a time consuming task if there are several hundred devices. To avoid this, normally a personal computer (PC) based application is written, which performs the installation or update of firmware or configuration of multiple devices in the network. However, updating in this manner requires a special program, and that program runs from a dedicated PC. It is an unnecessary overhead to have a special program on a dedicated PC.

### SUMMARY OF THE INVENTION

It is therefore an object of the present invention to provide a simple system for installing firmware and/or configuration files in multiple network devices in a network.

This and other objects and advantages are achieved in accordance with the invention by providing a network device having a second module that is used to enable the installation of firmware and/or configuration files in a plurality of network devices based on information received on the plurality of network devices in the network by a first module of the network device. A third module generates a web page that can be used to control the installation. As a result, a user who wishes to perform bulk installations of firmware/configuration files only needs to connect to the network device using the web page generated by the third module of the network device. This web page facilitates any web enabled client device to access the specified network device and perform the required installation without much complexity. In addition, the need for a complex application at the client device is avoided, which otherwise generally would be a dedicated PC.

In accordance with the invention, the required functionalities of the first, second and third modules form part of the network device as its internal firmware. Consequently, the vendor is not required to purchase special software nor is there a need for a dedicated PC to install bulk firmware/configuration of devices. Instead, the vendor can have a simple generic client device that is adapted to access the web page from the network device which helps him to perform the installation.

In a preferred embodiment, the information received by the first module includes the information on the type of each of the network devices. This enables the user to understand more about the network devices and the type of installation the network devices need. For example, some types of network devices need only an installation of a certain configuration while some others may need a firmware upgrade.

In a further preferred embodiment, the information received by the first module includes the current version of the firmware of each of the network devices. This enables the user to know about the current version of the firmware, so that he can judiciously select the installation.

In an alternative embodiment, the second module is can be configured to have a time based installation of the firmware and/or configuration files in the plurality of network devices. This provides the user with more flexibility to perform the installation. For example, an installation can be scheduled on non-peak hours, so that it does not affect the regular business time.

In an alternative embodiment, the location of source files for the installation of the firmware and/or configuration files is indicated using the web page. As a result, the user is permitted to select the location of the source file, even if the location is local or remote. Thus, the webpage is provided with a simple and user-friendly configuration.

In another alternative embodiment, the web page enables a selection of the network devices in the network for installation of the firmware and/or configuration files. This provides the user with the flexibility to choose only the required ones of the network devices that need the installation.

In another alternative embodiment, the client device is a PC or a web enabled mobile device. Thus, a simple PC or a web enabled device could be used for the installation, avoiding the need for a special dedicated PC for the application.

Other objects and features of the present invention will become apparent from the following detailed description considered in conjunction with the accompanying drawings. It is to be understood, however, that the drawings are designed solely for purposed of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described therein.

### BRIEF DESCRIPTION OF THE DRAWINGS

The present invention is further described hereinafter with reference to illustrated embodiments shown in the accompanying drawings, in which:

FIG. 1 illustrates a schematic block diagram of a network device for installation of the firmware and/or configuration files in accordance with an embodiment of the invention; and

FIG. 2 illustrates a schematic block diagram of a system for installation of the firmware and/or configuration files in accordance with an embodiment of the invention.

### DETAILED DESCRIPTION OF THE PRESENTLY PREFERRED EMBODIMENTS

Many network devices, such as access points, switches, routers or gateways, run a web server within them. Here, the desire is to have a web application which resides inside the network device, and perform the following functionalities:

Automatic discovery of devices in the network, and providing a list of the discovered devices;

Simultaneous installation/upgrade of multiple device firmware from a specified path, such as a path that is a Trivial File Transport Protocol (TFTP) server path; and

Simultaneous installation/update of multiple device configurations from a specified path at once, such as a path that is also a TFTP server path.

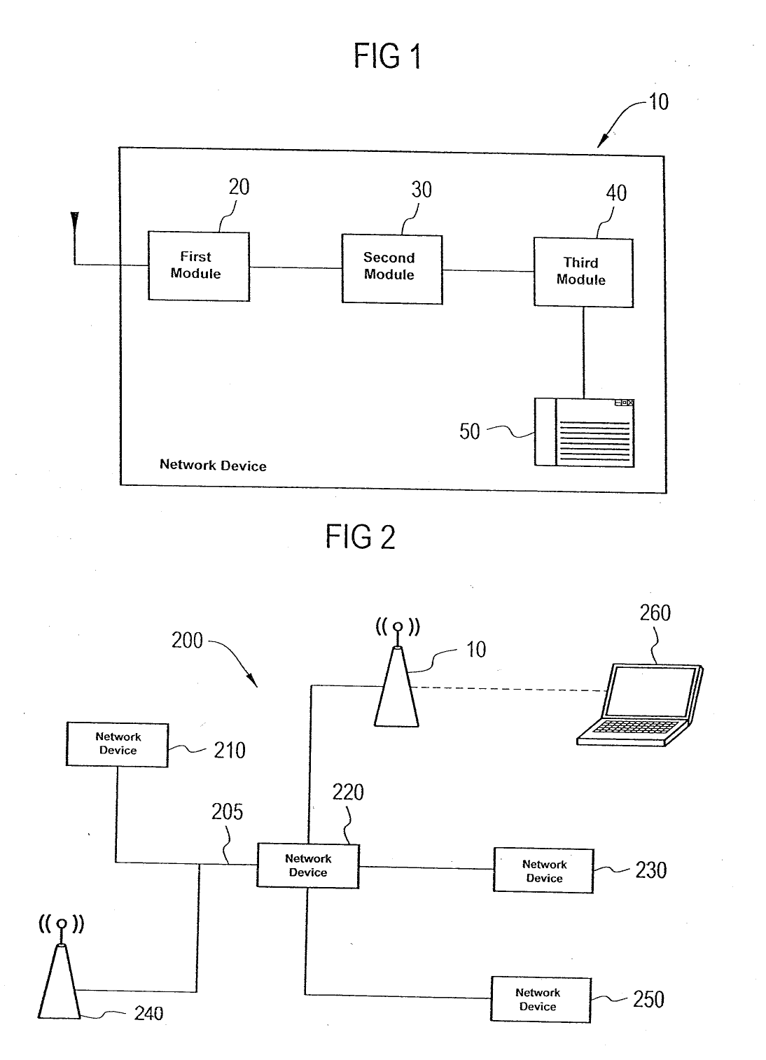

FIG. 1 illustrates a schematic block diagram of a network device 10 for installation of the firmware and/or configuration files in accordance with an embodiment of the invention. The network device 10 comprises a first module 20 configured to automatically receive information concerning a plurality of network devices in a network. The first module 20 scans through the network using specific protocols to discover the connected network devices in the network and also to gather information, such as the type of devices or the version of the installed firmware. Here, the discovered information can be used by the user to plan or schedule the required installation.

The network device 10 also includes a second module 30, which is configured to enable the installation of the firmware and/or configuration files in the plurality of network devices selected by the user, based on the received information received by the first module 20. The received information is basically processed by this second module 30. The user input for the installation is also processed by this second module 30. The second module 30 can be configured to have a time-based installation of the firmware and/or configuration files in the plurality of network devices.

The network device 10 also includes a third module 40 configured to generate a web page 50 to allow remote control of the installation of the firmware and/or configuration files. Typically, a user accesses the specific web page 50 generated by the third module 40 from a laptop/PC/web-enabled mobile device connected to the network. The connection could be wired or wireless. The web page enables the remote installation of the firmware/configuration files.

FIG. 2 illustrates a block diagram of a system 200 for installation of the firmware and/or configuration files in accordance with an embodiment of the invention. The system 200 comprises a network device 10 as explained in accordance with FIG. 1 in a network 205 of a plurality of network devices (210, 220, 230, 240, 250). As required, the user can select a simultaneous installation of firmware and/or configuration files in all or some of the networking devices (210, 220, 230, 240, 250) based on the requirement.

The system 200 further comprises a client device 260, adapted to access a web page 50 from the network device 10 to control the installation of the firmware/configuration files. The client device 260 could be a PC or a web-enabled mobile device. Using the web page 50, the location of source files for the installation of the firmware and/or configuration files can be indicated. Here, the user will be able to see a list of the network devices discovered by the network device 10 in this web page 50. The user can then select either all the network devices or some of the network devices according to the particular requirement of the user.

The user will also be able to select the location from where the firmware/configuration information has to be taken for the installation. The firmware/configuration gets installed in user requested network devices using device specific protocols, and the status can be shown to the user though the same web page 50. The location of the source file and the network devices that need to be installed with the firmware/configuration can be selected using the web page 50.

The present invention thus provides the network device 10 having the second module 30 to enable the installation of firmware and/or configuration files in the plurality of network devices (210, 220, 230, 240, 250) based on information received on the plurality of the network devices (210, 220, 230, 240, 250) in the network 205 by the first module 20 of the network device 10. The disclosed invention also provides a system 200 for the use of such an installation. The system 200 introduces a facility to have the discovery of the network devices (210, 220, 230, 240, 250) and to have a configuration/firmware update for multiple devices together from a web application running within the network device 10. Hence, the present invention permits the avoidance of the use of third party software. This is a more convenient approach, where the user can connect to the concerned network device 10 through a laptop/PC/web-enabled device and simply access the web page 50 to perform the installations.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A network device comprising:
a first module configured to automatically receive information concerning a plurality of other network devices in a network;
a second module configured to enable installation of at least one of firmware and configuration files in the plurality of other network devices based on the received information; and
a third module configured to generate a web page to remotely control the installation of the at least one of firmware and configuration files.

2. The network device as claimed in claim 1, wherein the information received by the first module includes information on each type of the plurality of other network devices.

3. The network device as claimed in claim 1, wherein the information received by the first module includes a current version of the firmware of each type of the other network devices.

4. The network device as claimed in claim 2, wherein the information received by the first module includes a current version of the firmware of each type of the other network devices.

5. The network device as claimed in claim 1, wherein the second module is configurable to enable a time based installation of the at least one of firmware and configuration files in the plurality of other network devices.

6. The network device as claimed in claim 1, wherein a location of source files for the installation of the at least one of firmware and configuration files is indicated by the web page.

7. The network device as claimed in claim 1, wherein the web page enables selection of a subset of the plurality of other network devices in the network for the installation of the at least one of firmware and configuration files.

8. A system comprising:
a network of a plurality of the network devices configured for simultaneous installation of at least one of firmware and configuration files;
a further network device comprising:
a first module configured to automatically receive information on the plurality of network devices in the network;
a second module configured to enable installation of the at least one of firmware and configuration files in the plurality of network devices based on the received information; and
a third module configured to generate a web page to facilitate remote control of the installation of the at least one of firmware and configuration files; and
a client device configured to access the web page from the further network device to control at least one of the installation of the firmware and upload of the configuration files.

9. The system as claimed in claim 8, wherein the client device is a PC.

10. The system as claimed in claim 8, wherein the client device is a web enabled mobile device.

11. The system as claimed in claim 9, wherein the PC is a web enabled mobile device.

12. The system as claimed in claim 8, wherein a location of source files for the installation of at least one of the firmware and the configuration files is indicated by the web page.
